(19) United States
(12) Patent Application Publication
(10) Pub. No.: US 2026/0307645 A1
(43) Pub. Date: Oct. 8, 2026

(54) CONTROLLING AN ENGINE START OF A HYBRID VEHICLE

(71) Applicant: JAGUAR LAND ROVER LIMITED, Whitley, Coventry, Warwickshire (GB)

(72) Inventors: Romain LACROISILLE, Whitley, Coventry, Warwickshire (GB); Daniel VAQUERIZO SANCHEZ, Whitley, Coventry, Warwickshire (GB); William HARRISON, Whitley, Coventry, Warwickshire (GB); Gareth WAIN, Whitley, Coventry, Warwickshire (GB)

(21) Appl. No.: 19/484,225

(22) PCT Filed: May 16, 2024
(86) PCT No.: PCT/EP2024/063533

§ 371 Date: Nov. 13, 2025

(30) Foreign Application Priority Data
May 17, 2023 (GB) 2307310.9

(51) Int. Cl. B60W 20/13; B60W 10/06; B60W 10/08; B60W 20/50; B60W 50/00; B60W 50/10; F02N 11/08

(52) U.S. Cl. CPC B60W 20/13; B60W 10/06; B60W 10/08; B60W 20/50; B60W 50/0097; B60W 50/10; F02N 11/0859; B60W 2510/1005; B60W 2510/244; B60W 2540/10; F02N 2200/061; F02N 2200/0801; F02N 2200/0802; F02N 2200/101

(57) ABSTRACT

A control system for controlling an engine start of a hybrid vehicle includes one or more processors configured to receive a first input signal indicating that a vehicle mode has been selected in which the use of an electric traction motor as a sole source of motive power is prioritised; receive a power demand signal indicative of a power request; receive an engine start signal indicating that an engine start is required; determine, in dependence on the power demand signal and engine start signal, whether the power request is below a power threshold of the electric traction motor; and output a control signal to the powertrain system to perform the engine start using a starter motor if the power request exceeds the power threshold, and to perform the engine start using the electric traction motor if the power request is below the power threshold.

### TECHNICAL FIELD

The present disclosure relates to controlling an engine start of a hybrid vehicle. Aspects of the invention relate to a control system, a system, a vehicle, a method and compute readable instructions.

### BACKGROUND

It is known for vehicles to be powered by an internal combustion engine and one or more electric traction motors (also referred to as electric motors (EM)). Such hybrid powertrain systems may operate in different modes at different times depending on the environment and needs of the driver of the vehicle. As one example, a driver may select an operating mode in which use of the electric traction motor as the sole source of motive power is prioritised, however, it may become necessary to start the engine such that both the electric traction motor and the engine are operated. Typically, in such scenarios, a starter motor will always be used to start the engine, but this can result in early hardware degradation and noticeable degradation in the noise, vibration and harshness (NVH) characteristics of the vehicle.

It is an aim of the present invention to address one or more of the disadvantages associated with the prior art.

### SUMMARY OF THE INVENTION

Aspects and embodiments of the invention provide a control system, a system, a vehicle, a method and computer readable instructions as claimed in the appended claims.

This disclosure provides a technique for controlling an engine start of a hybrid vehicle operating in a mode in which use of the electric traction motor as the sole source of motive power is prioritised. The technique determines whether to perform an engine start using a starter motor of the engine or the electric traction motor depending on the power being demanded when the engine start is required.

According to an aspect of the present invention there is provided a control system for controlling an engine start of a hybrid vehicle having a powertrain system comprising an electric traction motor and an engine with a starter motor, the control system comprising one or more processors. The one or more processors are collectively configured to receive a first input signal indicating that a vehicle mode has been selected in which the use of the electric traction motor as a sole source of motive power is prioritised, receive a power demand signal indicative of a power request, and receive an engine start signal indicating that an engine start is required. The one or more processors are further configured to determine, in dependence on the power demand signal and engine start signal, whether the power request is below a power threshold of the electric traction motor, and output a control signal to the powertrain system to perform the engine start using the starter motor if the power request exceeds the power threshold, and to perform the engine start using the electric traction motor if the power request is below the power threshold.

In this way, when the vehicle is operating in a mode in which the use of the electric traction motor as a sole source of motive power is prioritised, the control system allows the use of the starter motor to start the engine to maximise the extent to which the driver can make use of the electric traction motor power capability, while also enabling use of the electric traction motor to start the engine when the power being demanded is below the power threshold. This can prevent early degradation of the hardware (e.g., the starter motor) and improve the noise, vibration and harshness (NVH) characteristics of the vehicle when operating in a mode in which the use of the electric traction motor as a sole source of motive power is prioritised, without compromising the power available to the driver when demanded.

The control system comprises one or more controllers collectively comprising at least one electronic processor having an electrical input for receiving an input signal; and at least one memory device electrically coupled to the at least one electronic processor and having instructions stored therein; and wherein the at least one electronic processor is configured to access the at least one memory device and execute the instructions thereon so as to receive a first input signal indicating that a vehicle mode has been selected in which the use of the electric traction motor as a sole source of motive power is prioritised; receive a power demand signal indicative of a power request; receive an engine start signal indicating that an engine start is required; determine, in dependence on the power demand signal and engine start signal, whether the power request is below a power threshold of the electric traction motor; and output a control signal to the powertrain system to perform the engine start using the starter motor if the power request exceeds the power threshold, and to perform the engine start using the electric traction motor if the power request is below the power threshold

Optionally, the power threshold is a maximum power capability of the electric traction motor. For example, the power threshold may correspond to the upper limit of the amount of power from a traction battery of the powertrain system available for use by the electric traction motor. In this way, if the power being demanded is less than the power available to the electric traction motor, the electric traction motor will be used to perform the engine start. If the power being demanded exceeds the power available to the electric traction motor, the starter motor will be used to perform the engine start.

Optionally, the engine start signal is received in response to one or more of a power output signal indicating that the electric traction motor is outputting a power close to its maximum power capability, a traction battery charge signal indicating a low state of charge of a traction battery, a power demand signal indicating an increasing power request, a full depression signal indicating a full depression of an acceleration pedal of the vehicle, a user input signal requesting an engine start, a fault signal indicating a fault in a component of the powertrain system, a terrain mode signal indicating a terrain mode requiring an engine start, and a transfer box setting indicating a gear selection requiring an engine start. In this way, when the vehicle is operating in a mode in which the use of the electric traction motor as a sole source of motive power is prioritised, an engine start may be initiated if the user requests the use of the engine or if the operating conditions of the vehicle require the use of the engine as a source of motive power.

Optionally, in response to the engine start signal, the control system is configured to determine, in dependence on one or more operating conditions of the vehicle, a predicted gear selection associated with an engine start, determine, in dependence on the predicted gear selection and the one or more operating conditions, a first portion of a power capability of the electric traction motor for use in offsetting a gear ratio reduction, and output a control signal to the powertrain system to make the first portion of the power capability available for use in offsetting the gear ratio reduction. As such, a portion of the power capability of the electric traction motor is made available for use in offsetting a change in gear ratio as the engine is started, the remaining power capability of the electric traction motor thus defining the power threshold used to determine whether to perform the engine start using the starter motor or the electric traction motor. In this way, the control system determines whether the electric traction motor has enough power capability to perform an engine start without a noticeable reduction in performance, and if not, the starter motor will be used.

Optionally, the one or more operating conditions comprise a current gear selection and a speed of the vehicle. For example, the predicted gear selection may be determined by comparing the current gear selection and vehicle speed to a look up table stored in a memory of the control system.

According to another aspect of the invention, there is provided a system comprising the control system as mentioned above and a powertrain system comprising an electric traction motor and an engine with a starter motor.

Optionally, the starter motor is a pinion start motor selectively couplable to the powertrain system.

According to yet another aspect of the invention, there is provided a vehicle) comprising the system as mentioned above, or the control system as mentioned above.

According to a further aspect of the invention, there is provided a method for controlling an engine start of a hybrid vehicle having a powertrain system comprising an electric traction motor and an engine with a starter motor. The method comprises receiving a first input signal indicating that a vehicle mode has been selected in which use of the electric traction motor as a sole source of motive power is prioritised, receiving a power demand signal indicative of a power request, and receiving an engine start signal indicating that an engine start is required. The method further comprises determining, in dependence on the power demand signal and engine start signal, whether the power request is below a power threshold of the electric traction motor, and outputting a control signal to the powertrain system to perform the engine start using the starter motor if the power request exceeds or equals the power threshold, and to perform the engine start using the electric traction motor if the power request is below the power threshold.

Optionally, the power threshold is a maximum power capability of the electric traction motor.

Optionally, the engine start signal is received in response to one or more of a power output signal indicating that the electric traction motor is outputting a power close to its maximum power capability, a traction battery charge signal indicating a low state of charge of a traction battery, a power demand signal indicating an increasing power request, a full depression signal indicating a full depression of an acceleration pedal of the vehicle, a user input signal requesting an engine start, a fault signal indicating a fault in a component of the powertrain system, a terrain mode signal indicating a terrain mode requiring an engine start, and a transfer box setting indicating a gear selection requiring an engine start.

Optionally, upon receiving the engine start signal, the method further comprises determining, in dependence on one or more operating conditions of the vehicle, a predicted gear selection associated with an engine start, determining, in dependence on the predicted gear selection and the one or more operating conditions, a first portion of a power capability of the electric traction motor for use in offsetting a gear ratio reduction, and outputting a control signal to the powertrain system to make the first portion of the power capability available for use in offsetting the gear ratio reduction.

Optionally, the one or more operating conditions comprise a current gear selection and a speed of the hybrid vehicle.

According to a still further aspect of the invention, there is provided a computer readable instructions which, when executed by a computer, are arranged to perform the method as mentioned above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a block diagram illustrating a control system according to an embodiment of the present invention;

FIG. 2 shows a powertrain system according to an embodiment of the present invention;

FIG. 3A shows a schematic illustration of a vehicle according to an embodiment of the present invention;

FIG. 3B shows a schematic illustration of a rear-view of the vehicle of FIG. 3A;

FIG. 4 shows a first flow chart showing operations performed by the control system of FIG. 1 according to an embodiment of the present invention; and

FIG. 5 is a graph further illustrating an embodiment of the present invention.

### DETAILED DESCRIPTION

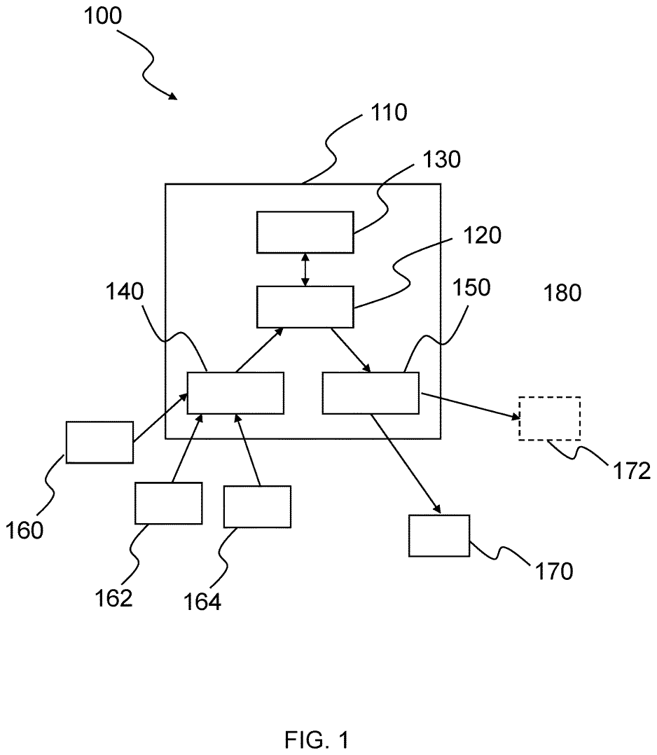

With reference to FIG. 1, there is illustrated a control system 100 for a vehicle. The control system 100 comprises one or more controller 110.

The control system 100 as illustrated in FIG. 1 comprises one controller 110, although it will be appreciated that this is merely illustrative. The controller 110 comprises processing means 120 and memory means 130. The processing means 120 may be one or more electronic processing device 120 which operably executes computer-readable instructions. The memory means 130 may be one or more memory devices 130. The memory means 130 is electrically coupled to the processing means 120. The memory means 130 is configured to store instructions, and the processing means 120 is configured to access the memory means 130 and execute the instructions stored thereon.

The controller 110 comprises an input means 140 and an output means 150. The input means 140 may comprise an electrical input 140 of the controller 110. The output means 150 may comprise an electrical output 140 of the controller 110. The input 140 is arranged to receive a vehicle operating mode signal 160 from one or more sensors indicative of the currently active vehicle operating modes. For example, the vehicle operating mode signal 160 may comprise an operating mode in which use of an electric traction motor (also referred to herein as an electric machine (EM)) as a sole source of motive power is prioritised. The vehicle operating mode signal 160 is an electrical signal which is indicative of at least one currently active operating mode of the vehicle. The input 140 is also arranged to receive an operating conditions signal 162 from one or more sensors indicative of one or more operating conditions of the vehicle. For example, the operating conditions signal 162 may include one or more of a power demand signal indicative of the power demand from a power demand sensor, a vehicle speed signal indicative of the speed of the vehicle from a vehicle speed sensor, and a gear selection signal indicative of a currently selected gear from a gear selection sensor. The operating condition signal 162 is an electrical signal which is indicative of one or more operating conditions of the vehicle. The input 140 is also arranged to receive an engine start signal 164 from one or more sensors indicative that an engine start is required. For example, the engine start signal 164 may comprise one or more of a power demand signal indicative of the power demand (e.g., by a driver) from a power demand sensor, an EM battery charge signal indicative of a state of battery charge of the EM battery from an EM battery power sensor, an EM power signal output indicative of a power currently output by the EM from an EM power output sensor, a full depression signal indicative of the initiation of a downshift in automatic transmission via the full depression of an acceleration pedal of the vehicle, a fault signal indicative of a fault in the powertrain system from a fault sensor, a user input signal via a human-machine interface (HMI) requesting an engine start, a terrain mode signal indicative of a terrain mode in which use of the engine is required, and a transfer box setting signal indicative of a gear selection in which use of the engine is required. The engine start signal 164 is an electrical signal which is indicative of an engine start being required such that both the EM and an engine are operated to deliver torque to the vehicle transmission, as will be described further below. The output 150 is arranged to output a start mode control signal 170 to thereby cause the powertrain system to perform an engine start using a particular start mode. For example, the start mode control signal 170 may control a starter motor to start the engine, or the start mode control signal 170 may control the EM to start the engine in accordance with one or more possible start modes. Optionally, the output 150 is arranged to output a power control signal 172 to thereby cause the powertrain system to make a portion of the power capability of the electric traction motor available for use in offsetting a gear ratio reduction.

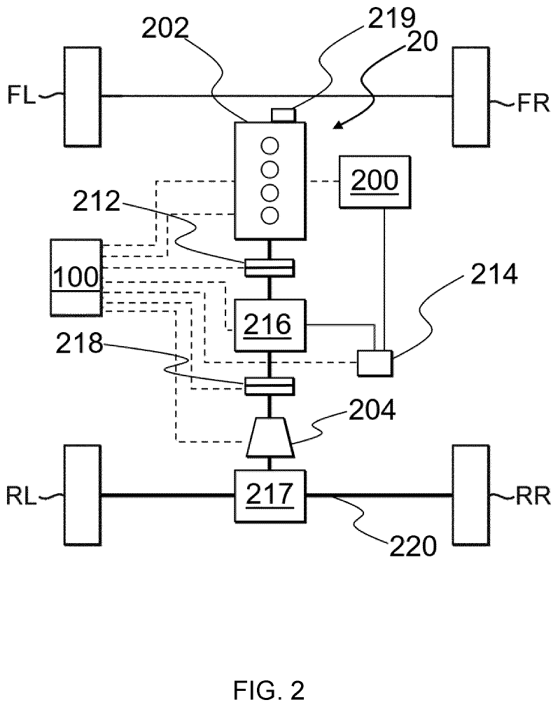

FIG. 2 illustrates an example system 20 for a parallel hybrid electric vehicle (HEV). The system 20 defines, at least in part, a powertrain of the HEV. The system 20 comprises the control system 100, as explained with reference to FIG. 1. The control system 100 may comprise one or more of: a hybrid powertrain control module; an engine control unit; a transmission control unit; a traction battery management system; and/or the like. The system 20 comprises an engine 202. The engine 202 may be a combustion engine. The illustrated engine 202 is an internal combustion engine. The illustrated engine 202 comprises four combustion chambers, however a different number of combustion chambers may be provided in other examples.

The engine 202 is operably coupled to the control system 100 to enable the control system 100 to control output torque of the engine 202. The output torque of the engine 202 may be controlled by controlling one or more of: air-fuel ratio; spark timing; poppet valve lift; poppet valve timing; throttle opening position; fuel pressure; turbocharger boost pressure; and/or the like, depending on the type of engine 202.

The system 20 further comprises an electric traction motor 216. In some embodiments, the system 20 has one electric traction motor. In other embodiments, the system 20 has more than one electric traction motor. The first electric traction motor 216 may be an alternating current induction motor or a permanent magnet motor, or another type of motor. The electric traction motor is also referred to herein as an electric machine (EM). The electric traction motor 216 may be a crankshaft integrated motor generator (CIMG). The electric traction motor 216 is configured to apply positive or negative torque to the crankshaft or to an output shaft connected to the crankshaft, for example to provide functions such as: boosting output torque of the engine 202; deactivating (shutting off) the engine 202 while at a stop or coasting; activating (starting) the engine 202; and regenerative braking in a regeneration mode. In a hybrid electric vehicle mode, the engine 202 and electric traction motor 216 may both be operable to supply positive torque simultaneously to boost output torque. The electric traction motor 216 may be capable of electric only driving.

The system 20 comprises a vehicle transmission arrangement 204 for receiving output torque from the engine 202 and/or from the electric traction motor 216. The vehicle transmission arrangement 204 may comprise an automatic vehicle transmission, a semi-automatic vehicle transmission, or a manual vehicle transmission.

The engine 202 is mechanically connected or connectable to the electric traction motor 216 via a first torque path connector in the form of a first clutch 212. The electric traction motor 216 is mechanically connected or connectable to the transmission 204 via a second torque path connector in the form of a second clutch 218. The second clutch 218 is illustrated in FIG. 2 as a single clutch located along the drive shaft between the electric traction motor 216 and the transmission 204. In other embodiments, the second clutch 218 could be integrated with the electric traction motor 216 and/or with the transmission 204. In the latter example, the second clutch could be a core clutch used for gear shifts. The function of the second clutch could be provided by a single clutch, as illustrated, or a by plurality of clutches which are each configured to connect the electric traction motor 216 to the transmission 204 and thereby fulfil the function of the second clutch. For example, the second clutch could comprise a clutch which is operable to connect the electric traction motor 216 to the transmission 204 when the transmission is in one of a first set of gears (e.g., gears 1-4) and one or more further clutches which are operable to connect the electric traction motor 216 to the transmission 204 when the transmission is in one of a second set of gears (e.g., gears 5-8). The electric traction motor 216 is mechanically connected or connectable to a first set of vehicle wheels (RL, RR) via a torque path which extends from an output of the electric traction motor 216 to the second clutch 218 then to the transmission 204, then to the axle/driveshafts 220, and then to the first set of vehicle wheels (RL, RR). The engine 202 is mechanically connected or connectable to the first set of vehicle wheels (RL, RR) via a torque path which extends from an output of the engine 202, then to the first clutch 212, then to the electric traction motor 216, then to the second clutch 218, then to the transmission 204, then to the axle/driveshafts 220, and then to the first set of vehicle wheels (RL, RR). One or both of the engine 202 and the electric traction motor 216 are able to provide torque to a first axle 220 of the vehicle. However, when the torque path between the electric traction motor 216 and the first set of vehicle wheels (RL, RR) is disconnected, the torque path 220 between engine 202 and the first set of vehicle wheels (RL, RR) is also disconnected. In a vehicle overrun and/or friction braking situation, torque may flow from the first set of vehicle wheels (RL, RR) to the electric traction motor 216 and optionally to the engine 202. Torque flow towards the first set of vehicle wheels (RL, RR) is positive torque, and torque flow from the first set of vehicle wheels (RL, RR) is negative torque. The illustrated first set of vehicle wheels (RL, RR) comprises rear wheels. Therefore, the illustrated system 20 is configured for rear wheel drive. In another example, the first set of vehicle wheels may be front wheels (FL, FR). The illustrated front wheels (FL, FR) is a pair of vehicle wheels, however a different number of vehicle wheels could be provided in other examples.

The system 20 may comprise a differential 217 for receiving output torque from the transmission 204, i.e., from the gear train. The differential may be integrated into the vehicle transmission arrangement 204 as a transaxle, or provided separately.

The illustrated system 20 comprises one electric traction motor 216. In other embodiments, the system 20 may have more than one electric traction motor. The system (20) may further comprise a starter motor 219 which is mechanically connected or connectable to the engine 202. For example, the starter motor 219 may be a belt integrated starter generator (BISG) or a pinion starter motor. In the illustration, the starter motor 219 is located at an accessory drive end of the engine 202, opposite a vehicle transmission end of the engine 202.

The control system 100 may be configured to disconnect the torque path between the engine 202 and the first set of vehicle wheels (RL, RR) in electric vehicle mode, for example to reduce parasitic pumping energy losses or to operate in an electric vehicle mode. For example, the first clutch 212 may be opened.

In some embodiments, the vehicle comprises another motive power source, or prime mover, arranged to provide torque to at least one wheel (FL, FR) of another axle of the vehicle. For example, the system (20) may further comprise a second electric traction motor (not shown) or a second internal combustion engine (not shown), either of which may provide positive torque alone or in combination with the electric traction motor 216 and/or the engine 202.

In order to store electrical power for the electric traction motor 216, the system 20 comprises a traction battery 200. The traction battery 200 provides a nominal voltage required by electrical power users such as the electric traction motor.

The traction battery 200 may be a high voltage (HV) battery. High voltage traction batteries provide nominal voltages in the hundreds of volts, as opposed to traction batteries for mild HEVs which provide nominal voltages in the tens of volts. The traction battery 200 may have a voltage and capacity to support electric only driving for sustained distances. The traction battery 200 may have a capacity of several kilowatt-hours, to maximise range. The capacity may be in the tens of kilowatt-hours, or in the hundreds of kilowatt-hours.

Although the traction battery 200 is illustrated as one entity, the function of the traction battery 200 could be implemented using a plurality of small traction batteries in different locations on the vehicle.

The system 20 may comprises one or more inverters 214. One inverter 214 is shown, for the electric traction motor 216. In other examples, two or more inverters could be provided.

It can be appreciated from the foregoing that the vehicle may be provided with motive torque from a combination of sources.

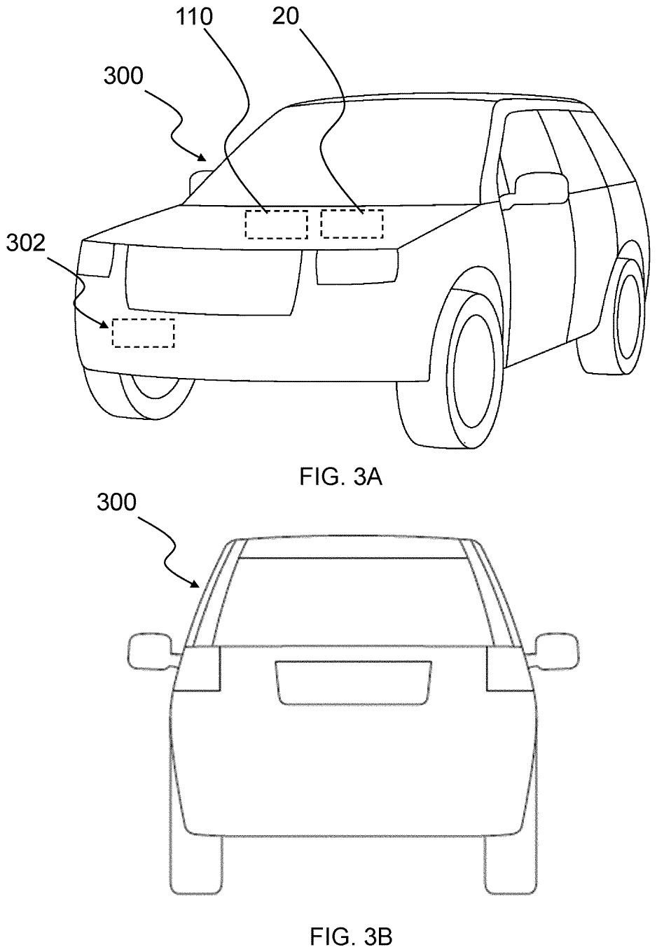

FIGS. 3A-B illustrate a vehicle 300 according to an embodiment of the present invention. The vehicle 300 comprises a control system 100 as illustrated in FIG. 1. The controller 110 is shown as mounted within the vehicle 300 and is in communication with the powertrain 20. The powertrain 20 is a hybrid powertrain system of the vehicle 300. The powertrain 20 comprises an engine 202 and an EM 216. The vehicle 300 also comprises an acceleration pedal 302. FIG. 3B illustrates a rear-view of the vehicle 300 of FIG. 3A.

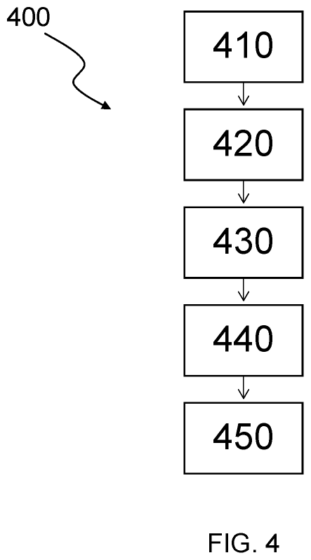

FIG. 4 illustrates a method 400 according to an embodiment of the invention. The method 400 is a method of controlling a hybrid powertrain system 20 of a vehicle 300, such as the vehicle 300 illustrated in FIGS. 3A and 3B, to perform an engine start. The hybrid powertrain system 20 is operable to perform an engine start using a plurality of engine start modes, the hybrid powertrain system 20 comprising an engine 202 (an internal combustion engine which may be powered by petrol, diesel, hydrogen, an e-fuel, for example, or any suitable combustible fuel) and an electric traction motor 216. The method 400 may be performed by the control system 100 illustrated in FIG. 1. In particular, the memory 130 may comprise computer-readable instructions which, when executed by the processor 120, perform the method 400 according to an embodiment of the invention.

When the vehicle 300 is operating such that only the electrical traction motor 216 is supplying output torque to the transmission 204, it can sometimes become necessary to initiate an engine start such that both the electric traction motor 216 and the engine 202 are operating to supply output torque. An engine start may be required for a variety of reasons, including but not limited to, an increase in power demand that requires a torque output that exceeds the power capability of the electric traction motor 216, a traction battery 200 having a low charge, the electric traction motor 216 outputting a power that is close to its maximum power capability, or the activation of a kick-down switch (e.g., below the acceleration pedal 302 of the vehicle 300) indicating a full depression of the acceleration pedal 302. Other reasons for performing an engine start may also include powertrain system issues (e.g., related to the function of the traction battery 200 or electric traction motor 216) or selection of a gear mode (e.g., low range mode or high range mode) that requires use of the engine 202.

The hybrid powertrain system 20 is operable to start the engine 202 using a number of different engine start modes. For example, the plurality of engine start modes may include a comfort slip start mode, a response slip start mode and a starter motor start mode.

A comfort slip start mode occurs when the first clutch 212 between the electric traction motor 216 and the engine 202 is partially engaged to start the engine while the second clutch 218 between the electric traction motor and the transmission 204 of the vehicle is also partially engaged, with the first and second clutches being fully engaged only once the engine speed is matched to the electric traction motor speed. This mode allows the vehicle to smoothly switch from using the electric traction motor only to using the engine either alone or in combination with the electric traction motor, by transferring torque from the electric traction motor to the engine via the first clutch to get the engine running prior to the switch. By slipping (i.e., partially engaging) the second clutch, oscillations or torque spikes which can occur due to the transfer of torque are damped, thus providing a smoother driver experience. In the following discussion, the comfort slip start mode is referred to simply as a slip start mode, since this is the normal type of slip start operation.

A response slip start mode occurs when the first clutch between the electric traction motor and the engine is partially engaged to start the engine and is fully engaged once the engine speed is matched to the electric traction motor speed, while the second clutch between the electric traction motor and the transmission remains fully engaged throughout. This differs from the comfort slip start mode above in that the second clutch is not slipped (i.e., the second clutch remains fully engaged). This mode can be used, for example, when driver demand is high, i.e., rapid acceleration is desired. This mode provides a faster vehicle response, but can mean that the ride is less smooth. In comfort slip start modes, oscillations can be less noticeable because the slipped clutch connecting the EM to the gearbox/wheels dampens the oscillations. This means the driver does not feel the oscillations as much. It can be important to have a fast controller in slip start modes because overshooting the engine/EM speed can have negative consequences on the NVH characteristics of the vehicle. Fast controllers have less overshoot than slow controllers.

A starter motor start mode occurs when the starter motor 219 is operated to start the engine 202. The starter motor 219 may be a belt integrated starter generator (BISG) or a pinion starter motor. This differs from the comfort slip start and response slip start in that no torque is transferred from the electric traction motor 216 to the engine 202. This mode can be used, for example, when driver demand is high, i.e., rapid acceleration is desired, or if the traction battery 200 is running low on charge. This mode also provides a faster vehicle response, but can again mean that the ride is less smooth.

When the vehicle 300 is operating in a mode in which use of the electric traction motor 216 as a sole source of motive power is prioritised, the starter motor 219 is typically used to start the engine 202 if an engine start is required, to thereby maximise the extent to which the power capability of the electric traction motor 216 is used for delivering torque to the transmission 204. However, use of the starter motor 219 as the sole engine start mode can result in early hardware degradation of the starter motor 219 and a noticeable degradation in the noise, vibration and harshness (NVH) characteristics of the vehicle 300. Therefore, if an engine start is required and the vehicle is operating in a mode in which use of the electric traction motor 216 as a sole source of motive power is prioritised, the method 400 determines whether to perform the engine start using the starter motor 219 or using the electric traction motor 216 (i.e., a slip start). In this way, the method 400 allows the use of the starter motor 219 to start the engine 202 to maximise the extent to which the driver can make use of the power capability of the electric traction motor 216, while also enabling use of the electric traction motor 219 to start the engine if the operating conditions of the vehicle allow. This can improve the NVH characteristics of the vehicle 300 when operating in a mode in which use of the electric traction motor 216 as a sole source of motive power is prioritised, without compromising the power available to the driver when demanded.

At step 410, the control system 100 is configured to receive a vehicle operating mode signal 160 indicating an operating mode in which use of the electric traction motor 216 as a sole source of motive power is prioritised. Optionally, the vehicle operating mode signal 160 is produced by the controller 110 based on receiving data relating to a user input (e.g., via a human-machine interface (HMI) of the vehicle 300) requesting the use of the electric traction motor 216 as a sole source of motive power.

At step 420, whilst the vehicle 300 is operating in a mode in which use of the electric traction motor 216 as a sole source of motive power is prioritised, the control system 100 is configured to receive an operating conditions signal 162 indicative of a power a request (e.g., from the driver). Optionally, this operating conditions signal 162 is produced by the controller 110 based on receiving data relating to a power demand signal indicative of the power demand.

At step 430, whilst the vehicle 300 is operating in a mode in which use of the electric traction motor 216 as a sole source of motive power is prioritised, the control system 100 is configured to receive an engine start signal 164 indicating that an engine start is required. Optionally, this engine start signal 164 is produced by the controller 100 based on receiving data relating to a power demand signal indicative of the power demand or an EM battery charge signal indicative of the state of battery charge of the traction battery 200 for the electric traction motor 216, an EM power signal output indicative of a power currently output by the electric traction motor 216, a full-depression signal indicative of the initiation of a downshift in automatic transmission, a fault signal indicative of a fault in the powertrain system, a user input signal via a human-machine interface (HMI) requesting an engine start, a terrain mode signal indicative of a terrain mode in which use of the engine is required, or a transfer box setting signal indicative of a gear selection in which use of the engine is required. For example, if the power demand signal indicates that the driver is requesting to accelerate such that a torque output required exceeds the capabilities of the electric traction motor, the engine start signal 164 will be generated. As another example, if the EM battery charge signal indicates that the battery charge of the traction battery 200 is too low to continue operating the powertrain system 20 using the electric traction motor 216 alone, the engine start signal 164 will be generated. As a further example, if the full depression signal indicates that the driver has activated the kick-down switch (i.e., by fully depressing the accelerator pedal 302) such that a downshift in automatic transmission is initiated, the engine start signal 164 will be generated. It will be appreciated that the full depression signal is indicative of a full depression of the acceleration pedal 302 and may be received in response to a kick-down switch below the acceleration pedal 302 or a displacement measurement from an accelerator pedal displacement sensor. Similarly, the acceleration pedal 302 may have a non-linear resistance that requires additional pressure to be applied to get full depression of the pedal 302, the full depression signal being received in response to the application of this additional pressure. As another example, if a fault signal is received indicating a fault in the electric traction motor 216, traction battery 200, inverter 214 or some other component of the powertrain system 20 such that use of the engine 202 is required, the engine start signal 164 will be generated. As yet a further example, if the driver requests an engine start via a HMI of the vehicle 300, the engine start signal 164 will be generated. As another example, if a terrain mode signal is received (e.g., in response to a user input via a HMI of the vehicle) relating to a terrain mode where use of the engine 202 is required (e.g., an off-road terrain mode), the engine start signal 164 will be generated. As a further example, if a transfer box setting signal is received (e.g., in response to a user input via a gear selector) relating to a gear selection in which use of the engine 202 is required (e.g., a high range gear setting or a low range gear setting), the engine start signal 164 will be generated.

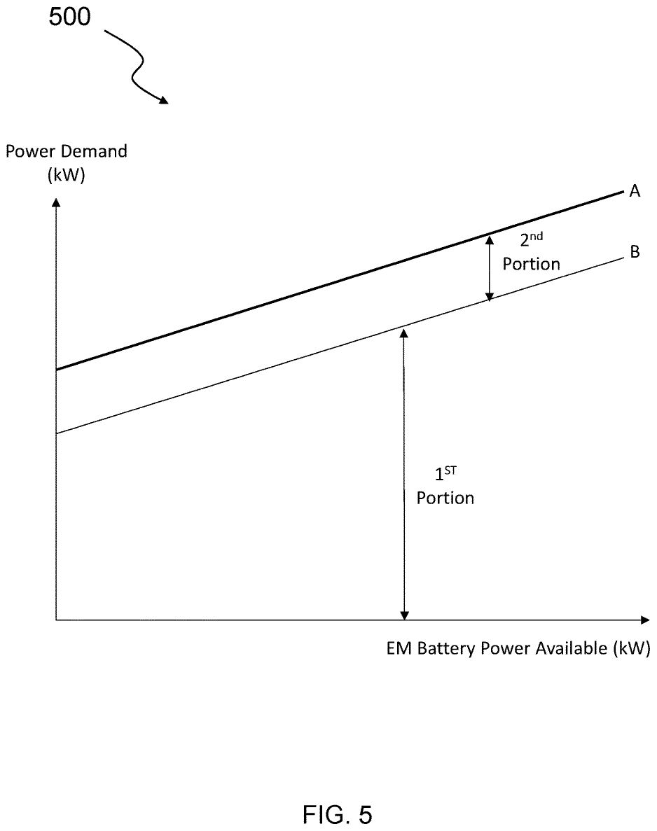

At step 440, in response to the engine start signal 164, the control system 100 is configured to determine in dependence on the power demand signal whether the power request is below a power threshold of the electric traction motor 216. Optionally, the power threshold corresponds to the upper limit of the amount of power from the traction battery 200 available for use by the electric traction motor 216 for delivering torque to the transmission 204. Optionally, as illustrated by the graph 500 shown in FIG. 5, the upper limit of the power available for use by the electric traction 216 for delivering torque to the transmission 204 may correspond to the maximum power capability (as denoted by line “A”) of the electric traction motor 216, which may in turn correspond to the maximum power available from the traction battery 200. Optionally, the upper limit of the power available for use by the electric traction 216 for delivering torque to the transmission 204 may correspond to a first portion of the maximum power capability of the electric traction motor 216 (as denoted by the region under line “B”), wherein one or more further portions of the power capability may be reserved or made available for other operational purposes. For example, a second portion of the maximum power capability B (i.e., the region between lines A and B) may be made available for use by the electric traction motor 216 in offsetting the torque increase needed to compensate for a gear ratio reduction which may occur when the engine 202 is first turned on, to thereby maintain expected vehicle acceleration. The gear ratio reduction may be requested due to differences in operating efficiency of the electric traction motor 216 and the engine 202 at different speeds. While dependent on vehicle speed, the most efficient operating speed for the electric traction motor 216 on its own is generally higher than the most efficient operating speed for the combination of the engine 202 and the electric traction motor 216. Consequently, before the engine 202 is started, the electric traction motor 216 may run at a higher speed than if the engine 202 is connected via the first clutch 212, and so when the engine 202 is started, an upshift in gear may be required to bring the speed of the electric traction motor 216 down for synchronisation with the lower desired speed of the engine 202. Whether or not an upshift, i.e., a gear ratio reduction, is desirable will depend on the vehicle speed, with an upshift being more favourable at some vehicle speeds than others. As such, after receiving the engine start signal 160, the control system 100 may be optionally configured to calculate, or otherwise determine, the portion of power capability needed for offsetting the gear ratio reduction, i.e., the second portion. In response to the engine start signal 160, the control system 100 may be configured to determine, in dependence on one or more of the operating conditions of the vehicle, a predicted gear selection associated with an engine start. For example, based on the current gear selection of the vehicle and a speed of the vehicle, the control system 100 may be configured to determine a predicted gear selection that will be needed when the engine 202 is started (i.e., whether there is an upshift). Optionally, the predicted gear selection may be determined by comparing the current gear selection to a look-up table stored in the memory 130. The control system 100 may then be configured to determine, in dependence on the predicted gear selection and vehicle speed, a portion of the power capability of the electric traction motor 216 needed for offsetting the expected reduction in gear ratio. Optionally, the portion of the power capability of the electric traction motor 216 needed for offsetting the expected reduction in gear ratio corresponds to the amount of torque required to maintain the wheel torque generated at the current vehicle speed with a different gear ratio. The control system 100 may then be configured to output a control signal to the powertrain system 20 to make that that portion of power capability available for use in offsetting the reduction in gear ratio, with the remaining portion of maximum power capability A (i.e., the region under line B) being made available for use in delivering torque to the transmission 204, and optionally, for use in performing a slip start. The second portion of the maximum power capability A can thus be considered as an “additional torque offset”. In such embodiments, the upper limit of the power available for use by the electric traction 216 for delivering torque to the transmission 204, i.e., the first portion of the power capability, may correspond to the maximum power capability A of the electric traction motor 216 minus the second portion which is made available for use in compensating for a gear ratio reduction. It will also be appreciated that one or more portions of the power capability of the traction battery 200 may be reserved for other operational purposes, such as operating air conditioning, screen heaters and other power consuming devices of the vehicle 300.

If the power demand does not exceed the power threshold, it can be determined that the electric traction motor 216 has power available for performing a slip start, and thus the electric traction motor 216 can be used to perform the engine start. If the power being demanded is equal to or exceeds the power threshold, then a slip start will be possible, and hence it can be determined that the engine start can be performed using the starter motor 219. Once the control system 100 has determined whether the power request is below a power threshold of the electric traction motor 216, the control system is configured to output, at step 450, a control signal 170 to cause the powertrain system 20 to start the engine 202 to perform the engine start using the starter motor 219 if the power request exceeds the power threshold, and to perform the engine start using the electric drive motor if the power request is below the power threshold. Optionally, if a starter motor start is selected, the control system 100 is configured to output a control signal 170 to the powertrain system 20 to operate the starter motor 219 to thereby start the engine 202, and then engage the first clutch 212 between the engine 202 and the electric traction motor 216 once the speed of the engine 202 matches the speed of the electric traction motor 216. Optionally, if a slip start is selected, the control system 100 is configured to output a control signal 170 to the powertrain system 20 to partially engage the first clutch 212 between the electric traction motor 216 and the engine 202, and partially or fully engage the second clutch 218 between the electric traction motor 216 and the transmission 204 to thereby transfer torque from the electric traction motor 216 to the engine 202, the first and second clutches 212, 218 both being fully engaged once the speed of the engine 202 matches the speed of the electric traction motor 216.

In this way, the method 400 allows the use of the starter motor 219 to start the engine 202 to maximise the extent to which the driver can make use of the power capability of the electric traction motor 216, while also enabling use of the electric traction motor 219 to start the engine 202 if the electric traction motor 216 has enough power available for performing a slip start.

It will be appreciated that various changes and modifications can be made to the present invention without departing from the scope of the present application.

1. A control system for controlling an engine start of a hybrid vehicle having a powertrain system comprising an electric traction motor and an engine with a starter motor, the control system comprising one or more processors, the one or more processors collectively configured to:
receive a first input signal indicating that a vehicle mode has been selected in which the use of the electric traction motor as a sole source of motive power is prioritised;
receive a power demand signal indicative of a power request;
receive an engine start signal indicating that an engine start is required;
determine, in dependence on the power demand signal and engine start signal, whether the power request is below a power threshold of the electric traction motor; and
output a control signal to the powertrain system to perform the engine start using the starter motor if the power request exceeds the power threshold, and to perform the engine start using the electric traction motor if the power request is below the power threshold.

2. The control system of claim 1, wherein the power threshold is a maximum power capability of the electric traction motor.

3. The control system of claim 1, wherein the engine start signal is received in response to one or more of:
a power output signal indicating that the electric traction motor is outputting a power close to its maximum power capability;
a traction battery charge signal indicating a low state of charge of a traction battery;
a power demand signal indicating an increasing power request;
a full depression signal indicating a full depression of an acceleration pedal of the vehicle;
a user input signal requesting an engine start;
a fault signal indicating a fault in a component of the powertrain system;
a terrain mode signal indicating a terrain mode requiring an engine start; and
a transfer box setting indicating a gear selection requiring an engine start.

4. The control system of claim 1, wherein, in response to the engine start signal, the control system is configured to:
determine, in dependence on one or more operating conditions of the vehicle, a predicted gear selection associated with an engine start;
determine, in dependence on the predicted gear selection and the one or more operating conditions, a first portion of a power capability of the electric traction motor for use in offsetting a gear ratio reduction; and
output a control signal to the powertrain system to make the first portion of the power capability available for use in offsetting the gear ratio reduction.

5. The control system of claim 4, wherein the one or more operating conditions comprise a current gear selection and a speed of the vehicle.

6. A system comprising the control system of claim 1, and a powertrain system comprising an electric traction motor and an engine with a starter motor.

7. The system of claim 6, wherein the starter motor is a pinion start motor selectively couplable to the powertrain system.

8. A vehicle comprising the control system of claim 1.

9. A method for controlling an engine start of a hybrid vehicle having a powertrain system comprising an electric traction motor and an engine with a starter motor, the method comprising:
receiving a first input signal indicating that a vehicle mode has been selected in which use of the electric traction motor as a sole source of motive power is prioritised;
receiving a power demand signal indicative of a power request;
receiving an engine start signal indicating that an engine start is required;
determining, in dependence on the power demand signal and engine start signal, whether the power request is below a power threshold of the electric traction motor; and
outputting a control signal to the powertrain system to perform the engine start using the starter motor if the power request exceeds or equals the power threshold, and to perform the engine start using the electric traction motor if the power request is below the power threshold.

10. The method of claim 9, wherein the power threshold is a maximum power capability of the electric traction motor.

11. The method of claim 9, wherein the engine start signal is received in response to one or more of:
a power output signal indicating that the electric traction motor is outputting a power close to its maximum power capability;
a traction battery charge signal indicating a low state of charge of a traction battery;
a power demand signal indicating an increasing power request;
a full depression signal indicating a full depression of an acceleration pedal of the vehicle;
a user input signal requesting an engine start;
a fault signal indicating a fault in a component of the powertrain system;
a terrain mode signal indicating a terrain mode requiring an engine start; and
a transfer box setting indicating a gear selection requiring an engine start.

12. The method of claim 9, wherein, upon receiving the engine start signal, the method further comprises:
determining, in dependence on one or more operating conditions of the vehicle, a predicted gear selection associated with an engine start;
determining, in dependence on the predicted gear selection and the one or more operating conditions, a first portion of a power capability of the electric traction motor for use in offsetting a gear ratio reduction; and
outputting a control signal to the powertrain system to make the first portion of the power capability available for use in offsetting the gear ratio reduction.

13. The method of claim 12, wherein the one or more operating conditions comprise a current gear selection and a speed of the hybrid vehicle.

14. Computer readable instructions which, when executed by a computer, are arranged to perform the method according to claim 9.
